(19) United States
(12) Patent Application Publication
(10) Pub. No.: US 2005/0244677 A1
(43) Pub. Date: Nov. 3, 2005

(54) Hybrid electronic device comprising a low-temperature-cofired-ceramic ltcc-tape

(76) Inventors: Vassilios Zaspalis, Thessaloniki (GR); Detlev Hennings, Aachen (DE); Rudiger Gunter Mauczok, Erkelenz (DE); Baby Seriyati Schreinemacher, Eynatten (BE)

Correspondence Address: PHILIPS INTELLECTUAL PROPERTY & STANDARDS, P.O. BOX 3001, BRIARCLIFF MANOR, NY, 10510, US

(21) Appl. No.: 10/515,468

(22) PCT Filed: May 19, 2003
(86) PCT No.: PCT/IB03/01919

§ 371 Date: Nov. 22, 2004

(30) Foreign Application Priority Data
May 24, 2002 (EP) 02011451.8

(51) Int. Cl. H01F 41/16

(52) U.S. Cl. 428/702; 252/62.56; 252/62.58; 252/62.62

(57) ABSTRACT

Hybrid electronic circuit structure comprising a low-temperature cofired ceramic (LTCC) tape and a ferromagnetic device, said device being formed by a ferromagnetic material, wherein said ferromagnetic material comprises a ferromagnetic oxide and a sintering agent material and wherein the sintering agent material comprises Zn4B6O13 (zinc boralith).

The present invention generally relates to a hybrid electronic device comprising a low-temperature-cofired-ceramic LTCC-tape, and more specifically a cofired LTCC-tape incorporating ferromagnetic devices, such as drop-in components, transformers, coils in low-pass filters and decoupling units.

One of major trends in electronic packaging industry is to use surface mount technology (SMT) as a replacement for conventional plated through-hole (PTH) technology. SMT offers several distinct advantages including greater packaging density, higher lead counts with shorter interconnection lengths and easier automation over PTH technology. Since SMT demands electronic devices and components to be mountable on the surface of a printed circuit board, the materials and structure of traditional leaded components including capacitors, resistors and inductors have to be redesigned to meet the requirements of short, thin, light and small electronic devices. In the past 30-year development of surface mounted passive components, inductor is the least successful one, because it has wire to wind and is difficult to miniaturized without degradation of magnetic properties. Magnetic shielding is also important, especially for high package density; therefore, the inductor has to be boxed to prevent magnetic flux leakage and cross talks between inductors. To fulfill the above requirements, the multilayer chip inductor (MLCI) is thus developed.

An approach to the fabrication of hybrid microcircuits is the cofired ceramic process. This technology utilizes dielectric material formed into sheets having alumina as a main component. Individual sheets of tape are printed with metallization and other circuit patterns, stacked on each other, laminated together at a predetermined temperature and pressure, and then fired at a desired high temperature at which the material fuses or sinters.

Where alumina is generally used as the insulating material, tungsten, molybdenum or molymanganese is typically used for metallization, and the part is fired to about 1600° C. in a reducing atmosphere containing hydrogen.

The undesirable high processing temperature and required hydrogen atmosphere, and more importantly the electrical performance of the refractory metals has led to the development of Low-Temperature-Cofired-Ceramic LTCC-tape.

The low-temperature processing permits the cofiring of magnetic ceramic layers with low-firing dielectric and glass ceramics as well as precious metal thick film conductors such as gold, silver, or their alloys.

Ferromagnetic compositions have been developed in the past for use with the thick film process. These compositions can be screen printed together with other paste layers onto a substrate to form cores or enhancers for inductors, magnetic shield planes, and other ferromagnetic devices. However, these compositions are not usable with the LTCC-process because they have a dissimilar shrinkage profile to LTCC-tape. This causes warping or buckling of the LTCC-tape structure during firing.

For this reason, magnetic components, including transformers, as well as non-magnetic components such as heat sinks and varistors have previously been fabricated separately and mounted on the surfaces of LTCC-structures. This is disadvantageous in that the space on the surfaces of the structures is severely limited, and should be utilized for the mounting of hybrid microelectronic integrated circuit chips and interconnects.

U.S. Pat. No. 5,312,674 A1 discloses a low-temperature-cofired-ceramic LTCC-tape structure including cofired ferromagnetic devices, drop-in components and multi-layer transformer, wherein a ferromagnetic material in ink or tape form is sinterable using a same firing profile as and has approximately the same thermal shrinkage characteristics as low-temperature-cofired-ceramic LTCC-tape, and is chemically non-reactive therewith. The ferromagnetic material includes three main components; a ferromagnetic oxide powder, a glass powder or “frit” and an organic binder or vehicle.

Such frit is usually composed of glass-forming compounds such as boron oxide, silicon oxide, germanium oxide, in most cases combined with glass modifiers such as lead oxide, bismuth oxide, alkaline earth oxides or ternary compounds such as borates or silicates. Especially useful, due to the many low-melting compositions they form, are borates or boron oxide which are widely applied as sintering agents.

In order to convert a ceramic powder in the shape of a thin foil, the powder particles have to be dispersed in a liquid to form a slurry. This slurry is mixed with organic additives and, as the main constituent, with an organic binder to form a ceramic slip suitable for foil casting. The binder provides strength to the foil so it can maintain its shape during the next processing steps (e.g. drying, electrode printing, stacking, laminating, sintering).

However, the commonly used boron containing compounds such as alkaline earth borates or borosilicate glasses cannot be used as sintering additives in combination with a water-based PVA binder system. Even traces of borate ions, which are dissolved in the aqueous suspensions from the boron containing additives during processing, lead to irreversible copolymerisation with PVA. The copolymerisation reaction causes gelation of the binder and hence the casting of foils is no longer possible.

For this reason organic solvents such as ethylene chloride or toluene are used to disperse ceramic powders with boron containing sintering additives followed by slip preparation with acrylic binder systems. However, because of the large amounts of ecologically harmful organic solvents which have to be removed during drying of the ceramic foils, a water based PVA binder system would be highly desirable for the production of ceramic foils with boron containing sintering additives.

Because of the environmental and technological problems mentioned above, it would be highly desirable to use a PVA compatible boron compound in combination with a ceramic powder and a water-based binder system for the production of green ceramic tapes which can be sintered at low temperatures. The boron compound should have the following properties:
insolubility in water, even as very fine powder;
rather low melting point;
good sintering properties when melted (low viscosity of liquid phase, good wetting of ceramic particles, solution and reprecipitation of ceramic).

It is therefore an object of the present invention to provide a hybrid electronic circuit structure comprising a low-temperature co-fired ceramic (LTCC) tape and a ferromagnetic device, said device being formed by a ferromagnetic material, wherein said ferromagnetic material comprises a ferromagnetic oxide and a sintering agent material sinterable at low temperatures to high densities.

The object can be attained by a hybrid electronic circuit structure comprising a low-temperature co-fired ceramic (LTCC) tape and a ferromagnetic device, said device being formed by a ferromagnetic material, wherein said ferromagnetic material comprises a ferromagnetic oxide and a sintering agent material and wherein the sintering agent material comprises Zn₄B₆O₁₃ (zinc boralith).

The crystalline borate material zinc boralith is anhydrous cubic zinc metaborate having the formula: Zn₄B₆O₁₃. This material, which crystallizes in the highly symmetrical sodalite structure type, is insoluble in water and has a melting point of about 980° C.

Such a low-fire ferromagnetic composition can be densified up to 95% at temperatures between 800-1000° C. within 60 minutes.

The sintering temperature of the well-known high-frequency ferromagnetic Z-Ferroxplana material Ba₃Mn₂Fe₂₄O₄₁ can be decreased from 1300° C. to a 1000° C. using the double oxide compound 4Zn.3B₂O₃ as a sintering agent. The magnetic properties of such low-fired Z-Ferroxplana material are suitable even at microwave frequencies up to 2 GHz. The material can be fired in nitrogene atmosphere and is thus a suitable candidate for cofiring with Ag/Pd and Cu electrodes together with other low-firing dielectric and glass-ceramic materials in LTCC substrates.

Lowering the sintering temperatures (i.e. below 1000° C.) would enhance the integration possibilities of ferromagnetic devices and associated functions in LTCC (Low Temperature co-fired Ceramics) semiconductor substrates leading to smaller, highly integrated and better performing chip modules with substrate integrated interconnects and microwave magnetic functions. Especially the sintering temperature of the well-known high-frequency ferromagnetic Z-Ferroxplana material Ba₃Mn₂Fe₂₄o₄₁ has been decreased from 1300° C. to about 1000° C., using the zinc boralith as a sintering agent. The magnetic properties of such low-fired Z-Ferroxplana material are suitable even at microwave frequencies up to 2 GHz. The material can be fired in nitrogen atmosphere and is thus a suitable candidate for cofiring with Ag/Pd and Cu electrodes together with other low-firing dielectric and glass-ceramic materials in LTCC substrates.

In one embodiment of the invention said ferromagnetic oxide can be selected from the group consisting of spinels, including magnetoplumbites and garnets.

In another embodiment of the invention said ferromagnetic oxide is a ferroxplana oxide selected from the group of ferroxplana oxides with Z-, M-, Y—, U— and X-hexagonal structure.

The sintering agent material may comprise further oxide additives, which are chosen from the group consisting of ZnO, CuO, Bi₂O₃, CaCO₃, SrCO₃, BaCO₃, TiO₂, ZnSiTiO₅ and GeO₂ and mixtures thereof.

In combination with cubic zinc metaborate, several low melting compositions are accessible with these oxides. Such mixtures show similar properties to the well known sintering additives B₂O₃, BaB₂O₄ or PbB₂O₄, e.g. low melting points, low viscosity of liquid phase, good wetting and solution/reprecipitation of a variety of different ceramic powder materials used in the electronics industry.

The invention also relates to a ferromagnetic material comprising a ferromagnetic oxide and a sintering agent material, wherein the sintering agent material is Zn₄B₆O₁₃ (zinc boralith).

These and other features and advantages of the present invention will be apparent to those skilled in the art from the following detailed description.

The invention concerns a hybrid electronic circuit structure comprising a low-temperature cofired ceramic (LTCC) tape and a ferromagnetic device, said device being formed by a ferromagnetic material, wherein said ferromagnetic material comprises a ferromagnetic oxide, a sintering agent material and an organic binder, wherein the sintering agent material is Zn₄B₆O₁₃ (zinc boralith).

Examples of preferred embodiments of ferromagnetic devices which have been determined to be cofirable with LTCC-tape are magnetic inductors and transformer cores, magnetic shields and other applications such as chip modules with substrate integrated interconnects and microwave magnetic functions, EMI absorbers, microwave filters and switches, gyrators and actuators. It will be understood, however, that these particular examples do not limit the scope of the invention.

The ferromagnetic oxide may be selected from any of the three main groups of ferrites: spinel, garnet and magnetoplumbite, depending on the desired properties. Spinels have the general formula MOFe₂O₃, MFe₂O₄ or MFe₃O₄, where M is typically nickel (Ni), zinc (Zn), manganese (Mn), magnesium (Mg), lithium (Li), copper (Cu), cobalt (Co) or another element. Garnets have the general formula 3M₂O_{3.5.}Fe₂O₃ or M₃Fe₅O₁₂, where M is most commonly yttrium (Y) or one of the rare earth ions. Magnetoplumbites have the general formula MFe₁₂O₁₉ or MO.6Fe₂O₃, where M is typically barium (Ba), gallium (Ga), chromium (Cr) or manganese (Mn). These ferromagnetic oxides can also be combined in many ways depending on a particular application.

The ferromagnetic oxide may also be selected from high-frequency Ferroxplana materials with Z, M, y, U or X hexagonal structures, which are well known in the literature.

They comprise materials such as (Ba₁₋ₓSrₓ)MeFe₆O₁₁ with Y-structure,(Ba₁₋ₓ—Srₓ)Me₂Fe₁₆O₂₇ with W-structure, (Ba₁₋ₓSrₓ)₃Me₂Fe₂₄O₄₁ with Z-Structure, (Ba₁₋ₓSrₓ)₂Fe₁₈O₃₀ with U-structure and (Ba₁₋ₓSrₓ)MeFe₁₄O₂₃ with X-structure wherein 0≦x≦1 and Me is a divalent metal ion selected from the group of Mn(II), Fe(II), Co(II), Ni(II), Cu(II), Zn(II) and Mg(II).

These materials show high permeability up to high frequencies (i.e. in the GHz region). They exhibit very interesting RF and microwave properties and can find applications in devices such as actuators, gyrators, microwave filters and switches, EMI absorbers etc.

The sintering agent comprises zinc borate Zn₄B₆O₁₃ (Boralith). The crystal lattice of zinc borate comprises a B₆O₁₂-host lattice of interlinked B0₄-tetrahedrons, wherein the six boron atoms are situated at the corners of a distorted octahedron. The thirteenth oxygen atom is not integrated in the B₆O₁₂-host lattice.

Said thirteenth oxygen atom is tetrahedrally surrounded by four zinc atoms. Consequently, the compound Zn₄B₆O₁₃ can also be re-formulated as OZn₄(B₆O₁₂). Zinc borate Zn₄B₆O₁₃ is prepared by mixing boron oxide B₂O₃ and zinc oxide ZnO in the molar ratio of 6:4 and firing said mixture at 950° C. for 2 hours. The complete conversion to zinc borate is checked by means of X-ray-photographic examinations. The fired zinc borate is ground so as to obtain an average grain size d₅₀<0.5 μm and subsequently washed.

The sintering agent may additionally comprise a compound selected from the group formed by CaO, CuO, SiO₂ CaSi0₃, ZnO and ZnSiTiO₅.

The average grain size of the compounds of the group formed by CaO, CuO, CaSi0₃, ZnO and ZnSiTi0₅ preferably is d₅₀<0.5 μm. Si02 is preferably used as a water-containing gel.

Table 1 gives examples for some sinter active mixtures.

TABLE 1
Examples for mixtures of sintering additives with cubic zinc
metaborate Zn₄B₆O₁₃. T_{liq} is the temperature of complete melting.

| Zn₄B₆O₁ | ZnO | CaCO₃ | SiO₂ | ZnSiTiO₅ | Bi₂O₃ | CuO | T_{liq} |
|---|---|---|---|---|---|---|---|
| ₃[mol] | [mol] | [mol] | [mol] | [mol] | [mol] | [mol] | [° C.] |
| 1 | 2 | — | — | — | — | 6 | 906 |
| 1 | — | — | — | — | — | 8 | 916 |
| 1 | 8 | 1 | 1 | — | — | — | 853 |
| 1 | 8 | — | 1 | — | — | — | 945 |
| 1 | 8 | — | 3 | — | 1 | — | 919 |
| 2 | — | — | — | 7 | — | 4 | 871 |
| 2 | — | — | — | 7 | 1 | 4 | 840 |

The material that can be selected for the electrodes used in the LTCC tape is not subject to particular limitations, so that a metal or a combination of two or more customarily used metals can be employed. The electrodes may be composed of noble metals selected from platinum, palladium and gold. The electrodes may alternatively contain a base metal selected from the base metals chromium, zirconium, vanadium, zinc, tin, lead, manganese, molybdenum, tungsten, titanium, aluminium, nickel, iron, cobalt and their alloys. Preferably, the electrodes are made of an electrode metal selected from the group formed by silver, copper and their alloys.

To manufacture the magnetic ceramic composition use can be made of the methods customarily used to manufacture powders, for example the mixed-oxide method, co-precipitation, spray drying, sol-gel method, hydrothermal methods or alkoxide methods. Preferably, use is made of the mixed-oxide method, wherein the starting oxides or thermally decomposable compounds, such as carbonates, hydroxides, oxalates or acetates are mixed and ground. Subsequently, the starting powder is calcined at a temperature in the range from 1000° C. to 1400° C.

To shape said calcined powder so as to form the green body, use can also be made of all customary methods. In the case of ceramic multilayer capacitors, first a suspension is prepared from the calcined powder, which suspension comprises, apart from said powder, solvents, binding agents and optionally softeners and dispersing agents as further components. The solvent may be, for example, water, alcohol, toluol, xylol or trichloroethylene. For the binder use is customarily made of organic polymers such as polyvinylalcohol, polyvinylbutyral or polymethylmethacrylate. For the softeners use can be made of glycerol, polyethylene oxide or phthalate. Furthermore, dispersing agents such as alkylarylpolyetheralcohols, polyethyleneglycolethylether or octylphenoxyethanol can be added to the suspension.

In another embodiment of the invention said organic binder comprises a water-soluble organic binder. A PVA based organic binder is preferred as water-soluble organic binder.

A PVA based organic binder is a mixture of functional organic compounds. Polyvinyl alcohol is the main constituent that binds the powder particles together into the form of a ceramic foil. PVA has a high cohesive strength and is therefore a good film former. Normally, PVA is used as a 10 wt. % solution in water. Because PVA has a glass transition point of about 85° C., the pure polymer is very brittle at room temperature and its pure use as binder would lead, after drying, to brittle ceramic foils that cannot be handled. For this reason a plasticizer like triethylene glycol is used for decreasing the glass transition point of the PVA binder. In addition, a small amount of an anti-foaming agent is added which helps to remove dissolved air. Other agents like wetting and release agents can also be added to the ceramic suspension to facilitate the foil casting process.

In accordance with a preferred method, green ceramic foils are manufactured from the suspension using a film-casting process. In said film-casting process, the suspension is poured onto a moving carrier surface. After evaporation of the solvent, a more or less flexible film remains, the flexibility being dependent on the binder system, which flexible film is cut, printed with a metal paste in accordance with the pattern of the inner electrodes using screen printing, and laminated. From the laminate, the individual multilayer tapes are cut. These individual multilayer tapes are first sintered in a slightly reducing atmosphere at temperatures ranging between 970° C. and 1050° C., after which they are tempered in a slightly oxidizing atmosphere at temperatures ranging between 600° C. and 800° C. For the slightly reducing atmosphere use can be made of water vapor-saturated nitrogen to which 0.5% to 2% by volume hydrogen is added, and for the slightly oxidizing atmosphere use can be made of nitrogen containing 5 ppm to 100 ppm oxygen.

The sintered ceramic has a homogeneous microstructure with grain sizes below 5 μm.

To form the outer contact electrodes, a metal paste containing, for example, nickel is applied to the end faces of the capacitors and subjected to a firing process. The outer 20 contacts may alternatively be provided by vapor deposition of a metal layer, for example of gold.

The ferromagnetic material is applied to the surfaces of LTCC-tape sheets to form desired devices such as cores for inductors and transformers and magnetic shields. Ferromagnetic vertical interconnects (vias) can be formed by punching holes through tape sheets and filling them with the ferromagnetic ink. The tape sheets and ferromagnetic devices are laminated together and cofired to form an integral structure.

A low-temperature-cofired ceramic LTCC-structure which includes ferromagnetic devices can be formed from ferromagnetic dispension or tape. The dispension is used in the same manner as other LTCC-dispensions or pastes, and is screen printed onto the surface of LTCC-sheets in the desired patterns to form flat layers or filled into holes to form vertical interconnects (vias). The tape is cut to the desired shape and placed on the surface of a sheet of LTCC tape.

The tape sheets and ferromagnetic devices are then sandwiched, laminated, prefired to bake out the organic vehicle materials and cofired at a temperature at which the LTCC tape and ferromagnetic material sinter (typically 850° C.) to form an integral cofired ceramic tape structure. The conventional LTCC processing technology is applicable without modification to fabricate structures in accordance with the present invention.

The ferromagnetic material is formulated to be chemically non-reactive with the LTCC tape, and have mechanical and thermal properties which are as close to those of LTCC tape as possible. In order to be cofirable, the ferromagnetic material must be sinterable using the LTCC firing profile. The ferromagnetic material must also have approximately the same thermal shrinkage characteristics, including shrinkage (10-15%) and shrinkage rate, as the LTCC tape in order to prevent warpage during firing.

The present ferromagnetic tape can be manufactured using the same technology as for LTCC tape.

### EXAMPLE 1

### Preparation of Ceramic Slurry

The ceramic powder, for example a magnetic material of composition Z-Ba₃Mn₂Fe₂₄O₄₁ is mixed with 2-5 wt % (with respect to the ceramic powder) of a mixture of 2.5 mol. % cubic zinc metaborate Zn₄B₆O₁₃, 18 mol. % CuO, 36 mol. % SiO₂ and 35 mol % ZnSiTiO₅ in demineralized water. The solid content of the slurry should be 65 wt %. In addition, 0.5 wt % of a polyelectrolyte, most preferably an ammonium salt of polyacrylic acid, is added to stabilize the suspension and to prevent reagglomeration of the powder particles. The slurry is homogenized by ball milling with yttria stabilized zirconia balls for 12 hrs.

### EXAMPLE 2

### Preparation of Ceramic Slip

In the following, concentrations of substances are given in wt % with respect to the solid content of the ceramic slurry.

The ceramic slurry is mixed with 5 wt % triethylene glycol while stirring. After 30 min, 6 wt % of PVA are added slowly as a 10 wt % aqueous solution. The viscosity of a 4 wt % aqueous solution of the PVA should be in the range from 20-56 cPs. The degree of hydrolysis of the PVA should be in the range from 88-98%. Also 0.1 wt % of an anti-foam agent like alcylamino polyethoxy polypropoxy propanol is added. To remove unwanted air the ceramic slip is outgased in vacuum while stirring.

### EXAMPLE 3

### Casting of a Ceramic Tape

In order to cast a ceramic tape, the slip is applied as a thin layer on a casting belt. The layer thickness is controlled by the speed of the casting belt. The slip layer is subsequently dried at 60° C. After drying, the tape is released from the belt and stored wrinkle-free on a reel.

### EXAMPLE 4

### Stacking and Firing of Ceramic Tape

The green ceramic tape is cut into the wanted shape and can then be equipped with Ag/Pd (5% Pd) metal electrodes by means of screen printing. Stacks of ceramic tapes can then be made by laminating under pressure and heat. The firing process is executed in two steps: First, the organic substances are burned out at 400° C. for 2 hrs and then the stacks or ceramic tape are fired at 950° C.-1000° C. for 1 hr until a density of the ceramic material of >98% with respect to the theoretical density is achieved.

Tests

To characterize the ferromagnetic materials in accordance with the invention, a Z-structure powder with Mn as Me has been mixed with various amounts from 1 to 4 wt. (%) of Zn₄B₆O₁₃ (Zn-boralith) phase. The mixture is milled to obtain a fine and homogeneous powder (i.e. particles of ca. 1-2 m). After milling the slurry has been dried and granulated using organic binders. From the so obtained granulate bars (for dilatometric measurements) toroids (for the magnetic measurements) and flat discs (for the dielectric measurements) have been pressed and sintered at various temperatures.

The densification behaviour of the samples during sintering in air atmosphere has been measured by the dilatometer.

Z-Ba3Mn2Fe24041 ferroxplana materials are typical high-firing materials which have to be fired at 1300° C. The addition of zinc boralith as sintering agent gives rise to a dramatic enhancement of the densification at lower temperatures. For example the shrinkage of pure Ba3Mn2Fe24041 Z-structure magnetic material at 1000° C. is only 2%. It becomes 12% after addition of 1 wt. % of zinc boralith and 17% with 3 wt. % 4ZnO.3B203. Sintering experiments in nitrogen atmosphere have shown that Z-Ferroxplana Material Ba₂Me₂Fe₂₄O₄₁ can also be sintered at low temperatures, using zinc boralith sintering agent. The magnetic, dielectric and insulating properties are similar to those of air-fired materials. In the following tables the magnetic and dielectric properties are shown for selected samples sintered at various temperatures with various additions of zinc boralith.

TABLE 2
Magnetic Measurements
Z -Ferroxplana mit 2.5 wt.-% zinc boralith

| | 101 Mhz, 25° C. | | | | 1.01 GHz, 25° C. | | | | 180 GHz 25° C. | | | |
|---|---|---|---|---|---|---|---|---|---|---|---|---|
| sint. temp (° C.) | 1050 | 1000 | 950 | 900 | 1050 | 1000 | 950 | 900 | 1050 | 1000 | 950 | 900 |
| Permeability μ | 2.36 | 2.17 | 2.02 | 2.01 | 3.11 | 2.81 | 2.56 | 2.49 | 6.77 | 5.92 | 5.23 | 4.81 |
| Loss (tan δ) | 0.77 | 0.77 | 0.55 | 0.66 | 8.4 | 7.4 | 7.1 | 9.8 | 29.0 | 25.4 | 23.1 | 26.6 |

As can be seen from Table 2,especially Z-Ferroxplana materials fired at 950-1050° C. with 2.5 wt. % Zn-boralith offer interesting magnetic properties in the high-frequency range up to 1.8 GHz.

Also the dielectric properties of Z-Ferroxplana, sintered at 950°-1050° C. in air with additions of Zn-boralith are interesting.

As can be seen in Table 3, Ferroxplana materials can also be used as dielectric material showing εᵣ˜20-25 and tan δ32 0.03-0.04 in the frequency range from 100 MHz to 1.8 GHz.

TABLE 3
Dielectric Measurements
Z -Ferroxplana

| | ε (101 MHz., 25° C.) | | | | ε.(1.01 GHz., 25° C. | | | | ε (180 GHz., 25° C.) | | | |
|---|---|---|---|---|---|---|---|---|---|---|---|---|
| sint. temp. (° C.) | 1050 | 1000 | 950 | 900 | 1050 | 1000 | 950 | 900 | 1050 | 1000 | 950 | 900 |
| 2.5% boralith | 20 | 19 | 18 | 19 | 20 | 19 | 17 | 19 | 21 | 20 | 18 | 20 |
| 5% boralith | 21 | 19 | 16 | 19 | 21 | 19 | 19 | 19 | 22 | 20 | 16 | 20 |

Especially Z-Ferroxplana materials, containing 2-5 wt. % zinc boralith, are promising candidates for preparing functional magnetic ceramic layers which can be co-fired with other low-firing dielectric and glass ceramic materials in so-called LTCC substrates. The low-firing magnetic material is suitable as functional substrate for inductivities, as for instance coils in low-pass filters and decoupling units. It has been successfully tested up to frequencies of 1.8 GHz. Z-Ferroxplana materials are thus specially interesting for use in the high-frequency telecommunication area.

1. Hybrid electronic circuit structure comprising a low-temperature cofired ceramic (LTCC) tape and a ferromagnetic device, said device being formed by a ferromagnetic material, wherein said ferromagnetic material comprises a ferromagnetic oxide and a sintering agent material, wherein the sintering agent material comprises Zn₄B₆O₁₃ (zinc boralith).

2. A structure as claimed in claim 1, in which said ferromagnetic oxide is selected from the group consisting of spinels, including magnetoplumbites and garnets.

3. A structure as claimed in claim 1, in which said ferromagnetic oxide is a ferroxplana selected from the group of ferroxplana oxides with Z-, M-, Y—, U— and X-hexagonal structure.

4. A structure as claimed in claim 1, in which the sintering agent material comprises further oxide additives which are chosen from the group consisting of ZnO, CuO, Bi₂O₃, CaCO₃, SrCO₃, BaCO₃, TiO₂, ZnSiTiO₅ and GeO₂ and mixtures thereof.

5. A ferromagnetic material comprising a ferromagnetic oxide and a sintering agent material, wherein the sintering agent material is Zn₄B₆O₁₃ (zinc boralith).
